(19) United States
(12) Patent Application Publication
(10) Pub. No.: US 2025/0289118 A1
(43) Pub. Date: Sep. 18, 2025

(54) ROBOT CONTROL DEVICE, ROBOT SYSTEM, AND TEACHING DEVICE

(71) Applicant: Fanuc Corporation, Minamitsuru-gun, Yamanashi (JP)

(72) Inventor: Takashi SATOU, Minamitsuru-gun, Yamanashi (JP)

(73) Assignee: Fanuc Corporation, Minamitsuru-gun, Yamanashi (JP)

(21) Appl. No.: 18/861,937

(22) PCT Filed: May 10, 2022
(86) PCT No.: PCT/JP2022/019846

§ 371 Date: Oct. 31, 2024

(51) Int. Cl. B25J 9/00; B25J 9/16; B25J 13/08

(52) U.S. Cl. CPC B25J 9/0081; B25J 9/1633; B25J 9/1664; B25J 13/084

(57) ABSTRACT

A robot control device for controlling a robot includes a teaching point setting unit that sets, as a teaching point of a robot program, a position of the robot when contact between the robot and an object is detected on the basis of an output of a first detector that is mounted on the robot and is able to detect contact.

### CROSS REFERENCE TO RELATED APPLICATIONS

This is the U.S. National Phase application of PCT/JP2022/019846, filed May 10, 2022, the disclosures of this application being incorporated herein by reference in its entirety for all purposes.

### FIELD OF THE INVENTION

The present invention relates to a robot controller, a robot system, and a teaching device.

### BACKGROUND OF THE INVENTION

A technique for creating a robot program by direct teaching in which an operator teaches a motion to a robot by directly operating the robot has been known. In regard to this, PTL 1 describes as follows: “When a lead-through operation is performed, a lead-through switch 44 is pressed so that contact force monitoring is disabled. Therefore, a robot 10 can be prevented from being unintentionally stopped due to an operation force applied to the robot 10 by an operator during the lead-through operation.” (paragraph 0037).

PTL 2 relates to a robot controller and describes as follows: “A control unit stores, as an initial reference state, the position and posture of a robot arm at an initial stage where an operator starts direct teaching by holding the robot arm and the like. Then, when the direct teaching starts, the control unit computes a force control signal according to positional information from a position detection unit and speed information from a speed detection unit, and transmits it to a driving unit to control a force or torque of an actuator for driving the robot arm. When the actuator is a linear motion system, the force is controlled, and when the actuator is a rotation system, the torque is controlled. When the operator applies a force to the robot arm to move the robot arm from the reference state, the control unit stores the position and posture of the robot arm as a teaching value of a trajectory.” (paragraph 0017).

### PATENT LITERATURE

[PTL 1] Japanese Unexamined Patent Publication (Kokai) No. 2015-199174 A
[PTL 2] Japanese Unexamined Patent Publication (Kokai) No. 2019-030931 A

### SUMMARY OF THE INVENTION

As techniques for creating a robot program by direct teaching, there are a technique in which a robot controller stores, at predetermined time intervals, positions on a trajectory along which a robot is moved by an operator, and a technique in which an operator operates a robot to stop at an important location and the position of the robot when the robot is stopped is stored.

The technique in which positions on a trajectory along which the robot moves are stored at predetermined time intervals is suitable for teaching a motion to the robot when a tool tip portion of the robot moves in the air without contacting any object. However, when a trajectory tracing a surface or an edge line of a workpiece is taught to a robot, a reaction force is applied to the robot at the time of contact between the robot and the workpiece. In this case, the reaction force is detected by a force sensor or a torque sensor mounted on the robot, and thus the robot is more likely to behave to leap in a direction away from the workpiece at a moment of contact with the workpiece. Since such a behavior of the robot is different from a motion of the robot that is intuitively expected by an operator, teaching of the robot is difficult.

In the technique in which the robot is stopped by an operator at an important location and a position of the robot is stored, the problem described above can be avoided by storing a position of the robot immediately before the robot contacts the workpiece. However, since utmost caution is needed in order to stop the robot at a position immediately before the robot contacts the workpiece, the advantage of direct teaching that an operator can perform teaching by an intuitive operation is lost.

One aspect of the present disclosure is a robot controller for controlling a robot, and the robot controller includes a teaching point setting unit configured to set, as a teaching point of a robot program, a position of the robot when contact between the robot and an object is detected, based on an output of a first detector capable of detecting contact with the object, the first detector being mounted on the robot.

Another aspect of the present disclosure is a robot system including: a robot on which a first detector capable of detecting contact with an object is mounted; and a teaching point setting unit configured to set, as a teaching point of a robot program, a position of the robot when contact between the robot and the object is detected, based on an output of the first detector.

Still another aspect of the present disclosure is a teaching device for teaching a robot, and the teaching device includes a teaching point setting unit configured to set, as a teaching point of a robot program, a position of the robot when contact between the robot and an object is detected, based on an output of a first detector capable of detecting contact with the object, the first detector being mounted on the robot.

According to the configuration described above, an operator can easily perform teaching operation when a trajectory including contact points with a workpiece, such as a trajectory tracing an edge line or a surface of a workpiece, is taught to a robot by the direct teaching.

The objects, the features, and the advantages, and other objects, features, and advantages will become more apparent from the detailed description of typical embodiments of the present invention illustrated in accompanying drawings.

### BRIEF DESCRIPTION OF DRAWINGS

FIG. 1 is an apparatus configuration diagram of a robot system according to a first embodiment.

FIG. 2 is a diagram illustrating a hardware configuration example of a robot controller and a teach pendant.

FIG. 3 is a functional block diagram of each apparatus constituting the robot system according to the first embodiment.

FIG. 4A is a diagram illustrating the operation of teaching an edge line of a workpiece by direct teaching.

FIG. 4B is a diagram illustrating the operation of teaching the edge line of the workpiece by the direct teaching.

FIG. 5 is a flowchart illustrating a procedure of the direct teaching.

FIG. 6 is a diagram illustrating an example of a program creation screen.

FIG. 7 is a diagram illustrating a setting screen of a direct teaching icon.

FIG. 8 is a diagram illustrating an example of a state where a direct teaching icon is developed and displayed.

FIG. 9 is an apparatus configuration diagram of a robot system according to a second embodiment.

FIG. 10 is a functional block diagram of the robot system according to the second embodiment.

FIG. 11 is a functional block diagram of a robot system according to a third embodiment.

### DETAILED DESCRIPTION OF EMBODIMENTS OF THE INVENTION

Next, embodiments of the present disclosure will be described with reference to drawings. A similar configuration portion or a similar functional portion is denoted by the same reference sign in the referred drawings. A scale is appropriately changed in the drawings in order to facilitate understanding. An aspect illustrated in the drawing is one example for implementing the present invention, and the present invention is not limited to the illustrated aspect.

Hereinafter, a robot system according to a first embodiment to a third embodiment will be described. The robot system according to each of the embodiments is a system that can perform direct teaching in which an operator performs teaching by directly operating a robot.

### First Embodiment

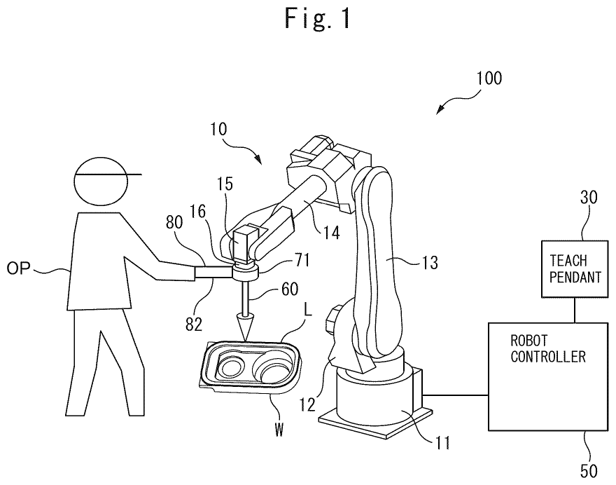

FIG. 1 is an apparatus configuration diagram of a robot system 100 according to a first embodiment. As illustrated in FIG. 1, the robot system 100 includes a robot 10, a robot controller 50 that controls the robot 10, and a teach pendant 30 used to perform various settings and operations related to teaching.

An example in which the robot 10 is a vertical articulated robot is described herein, but a robot of another type such as a parallel link robot and a dual arm robot may be used as the robot 10. The robot 10 includes a base 11 fixed to an installation floor, and a plurality of links mounted on the base 11. The plurality of links constitute a revolving barrel portion 12, a lower arm portion 13, an upper arm portion 14, and a wrist portion 15 of the robot.

The robot 10 can perform desired work by an end effector attached to a wrist flange 16. The end effector is an external device, which is exchangeable according to use, and is, for example, a hand, a welding gun, a tool, and the like. FIG. 1 illustrates an example in which a deburring tool 60 as one example of the end effector is used.

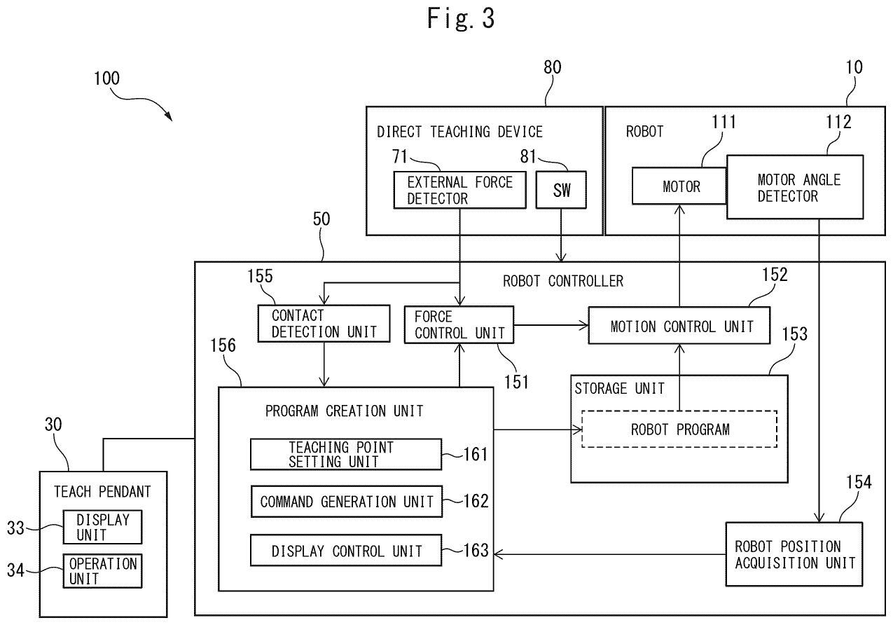

A direct teaching device 80 used when an operator performs direct teaching is further mounted on the wrist flange 16 of the robot 10. The direct teaching device 80 includes an operation handle 82, and an operation switch 81 (see FIG. 3) including a switch that switches enabling and disabling of the direct teaching operation and another functional switch. As illustrated in FIG. 1, the direct teaching device 80 is attached to the wrist flange 16 of the robot 10 via an external force detector 71. The deburring tool 60 is further attached closer to a tip side than the direct teaching device 80 with respect to the wrist flange 16 of the robot 10. A signal from the operation switch 81 is provided to the robot controller 50, and used for controlling the direct teaching operation.

The external force detector 71 can detect an external force applied to the robot 10. A force sensor or a load cell can be used as the external force detector 71. As an example, herein, the force sensor is assumed to be used as the external force detector 71. The force sensor is, for example, a 6-axis force sensor that detects a force in a 3-axis direction and moment about three axes. A detection value of the force sensor is input to the robot controller 50. It should be noted that the external force applied to the robot 10 may be detected by a torque sensor arranged on each joint axis of the robot 10. Alternatively, a force applied to the robot may be acquired from a current value flowing through a motor of each axis of the robot.

With this configuration, magnitude and a direction of an operation force acting on the robot when an operator OP operates the operation handle 82 of the direct teaching device 80 can be detected by the external force detector 71, and the robot 10 (arm tip portion) can be moved according to an operation by the operator OP.

The robot controller 50 has the function of controlling the robot 10 according to a robot program, the function of controlling the robot 10 according to a command from the teach pendant, the function of controlling the direct teaching operation in which the operator OP operates the robot 10 by using the direct teaching device 80, and the like.

An operator can create, by the direct teaching, a robot program for performing work on a workpiece W as illustrated in FIG. 1. The robot controller 50 allows an operator to easily perform the direct teaching for teaching, to the robot, a trajectory including contact points with a workpiece, such as a trajectory tracing an edge line, a surface, and the like of a workpiece.

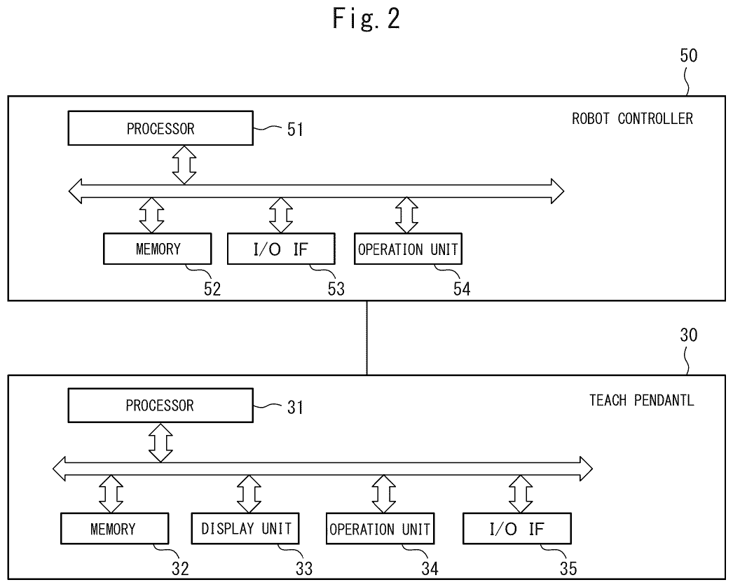

FIG. 2 illustrates a hardware configuration example of the robot controller 50 and the teach pendant 30. The robot controller 50 may have a configuration as a common computer in which a memory 52 (such as a ROM, a RAM, and a non-volatile memory), various input/output interfaces 53, an operation unit 54 including various operation switches, and the like are connected to a processor 51 via a bus. The teach pendant 30 may have a configuration as a common computer in which a memory 32 (such as a ROM, a RAM, and a non-volatile memory), a display unit 33, an operation unit 34 formed of an input device such as a keyboard (or a software key), various input/output interfaces 35, and the like are connected to a processor 31 via a bus.

FIG. 3 is a functional block diagram of each apparatus constituting the robot system 100. A motor 111 that drives a joint axis, and a motor angle detector 112 for detecting a position (angle position) of the motor are arranged in each joint portion of the robot 10. FIG. 3 illustrates the motor 111 and the motor angle detector 112 provided on one joint axis as a representative.

As illustrated in FIG. 3, the robot controller includes a force control unit 151, a motion control unit 152, a storage unit 153, a robot position acquisition unit 154, a contact detection unit 155, and a program creation unit 156.

The force control unit 151 has a function of generating a command for moving the robot 10 according to an external force detected by the external force detector 71. In the direct teaching, the force control unit 151 generates a motion command in such a way that the robot 10 moves in a direction of the external force detected by the external force detector 71 (a direction of a force applied to the robot 10 by the operator OP).

The motion control unit 152 generates a command for each joint axis of the robot 10 by kinematic calculation according to a command from the force control unit 151, and performs servo control on the motor of each joint axis. In this way, the robot 10 can be controlled according to the command from the force control unit 151. In this way, in the direct teaching, the function of moving the robot 10 (deburring tool 60) in a direction of a force applied to the operation handle 82 of the direct teaching device 80 by the operator OP is achieved.

A robot program created by the program creation unit 156, various types of information needed for programming, and the like are stored in the storage unit 153.

The external force detected by the external force detector 71 is further input to the contact detection unit 155, and contact between the robot 10 and an object is detected. The contact detection unit 155 may be configured to detect the contact between the robot 10 and an object, for example,
(1) when magnitude of a force or moment detected by the external force detector 71 exceeds a predetermined threshold value, or
(2) when a force or moment detected by the external force detector 71 is reversed.
   When the contact is detected, the contact detection unit 155 notifies the program creation unit 156 by sending a signal to the program creation unit 156.

A threshold value for the contact detection unit 155 to determine whether the contact with an object has occurred may be obtained, for example, by:
(1) a technique for recording a maximum force while the robot is operated by the direct teaching in a state where the robot 10 does not contact any object, and determining a value greater than the maximum force by a predetermined margin as the threshold value, or
(2) a technique in which a user can set the threshold value.

The robot position acquisition unit 154 acquires a position and a posture of the robot 10, based on an output of the motor angle detector 112 arranged on each joint axis. The robot position acquisition unit 154 provides information about the acquired position and posture of the robot 10 to the program creation unit 156.

The program creation unit 156 has various functions for creating a robot program. The functions of the program creation unit 156 include a function of creating a robot program by the direct teaching. As illustrated in FIG. 3, the program creation unit 156 includes a teaching point setting unit 161, a command generation unit 162, and a display control unit 163.

The teaching point setting unit 161 has a function of setting teaching points in the direct teaching. In the present embodiment, the teaching point setting unit 161 has a function of setting, as a teaching point, a position and a posture of the robot 10 when contact between the robot 10 and an object is detected by the contact detection unit 155.

The command generation unit 162 has a function of generating a motion command of the robot 10 based on the teaching point set by the teaching point setting unit 161.

The display control unit 163 has a function of generating various user interface (UI) screens for performing program creation, a function of supporting various operations via the UI screen, and the like.

In the present embodiment, various UI screens for programming are displayed on the display unit 33 of the teach pendant 30, and an operation on the UI screen is performed via the operation unit 34.

A specific operation example of the direct teaching according to the present embodiment will be described. Herein, a case where a trajectory along an edge line L of the workpiece Was illustrated in FIG. 1 is taught to the robot is assumed. A robot program in this case is a program for moving the deburring tool 60 in such a way as to trace an end surface (edge line L) of the workpiece W by the deburring tool 60.

Herein, a case where an edge line of such a workpiece is taught to the robot by a technique in which positions on a trajectory of the robot during movement of the robot are stored as teaching points at predetermined time intervals is considered. In this case, in order to teach the edge line L of the workpiece to the robot, the robot (tool) is brought into contact with the workpiece W, but, when the robot is brought into contact with the workpiece, a reaction force is applied to the robot. The reaction force is detected by the external force detector, and thus the robot is more likely to behave to move away from the workpiece. Therefore, in such a technique of the direct teaching, it is difficult for an operator to correctly teach, to the robot, a trajectory tracing the edge line. Further, even when the direct teaching is performed by an operator in such a way as to stop the robot at an important location and store the position of the robot when the robot is stopped, utmost caution is needed in order to stop the robot at a position immediately before the robot contacts the workpiece, and therefore the advantage of the direct teaching is lost. The robot controller 50 (program creation unit 156) according to the present embodiment solves, by a configuration in which a position and a posture of the robot when the robot 10 (deburring tool 60) contacts a workpiece can be acquired as a teaching point in the direct teaching, the above described problem which arises when an edge line and the like of the workpiece is taught to the robot by the direct teaching.

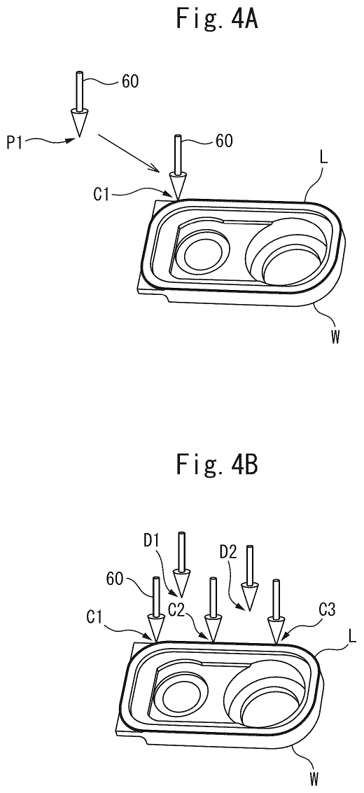

FIGS. 4A and 4B are diagrams illustrating an operation of teaching a trajectory of the edge line L of the workpiece W by the direct teaching according to the present embodiment. It should be noted that FIGS. 4A and 4B illustrate only the workpiece W and the deburring tool 60 for convenience of description. The operator OP performs a predetermined operation to start the direct teaching. The operation for starting the direct teaching may be performed by, for example, operating the operation switch 81 of the direct teaching device 80, or operating a UI screen displayed on the teach pendant 30. First, the operator OP records a teaching start point P1 while operating the robot 10 by using the direct teaching device 80. The operator OP causes the robot 10 (deburring tool 60) to approach the workpiece W from the teaching start point P1. The teaching point setting unit 161 may acquire positions of the robot 10 during movement from the teaching start point P1 to a first contact point C1 with the workpiece W at predetermine time intervals, and may automatically record the positions as teaching points.

The teaching point setting unit 161 automatically records, as a teaching point, the contact point C1 at which the deburring tool 60 first contacts the workpiece W. When the deburring tool 60 and the workpiece W contact each other, the robot 10 may behave to move away from the workpiece W, but a position D1 of the deburring tool 60 away from the workpiece W in this case is not recorded as a teaching point. The operator OP causes the deburring tool 60 to approach and contact the workpiece W again. A contact point C2 with the workpiece for this second time is also automatically recorded as a teaching point. The deburring tool 60 moves away from the workpiece W again, but a position D2 at this time is not recorded. Then, a contact point C3 at which the operator OP subsequently brings the deburring tool 60 into contact with the workpiece W is automatically recorded as a teaching point. The operator OP continues such an operation along the entire edge line L so as to set teaching points along the entire edge line L.

While the operator repeats such an operation, positions (contact points C1, C2, C3, and . . . ) at which the deburring tool and the workpiece W contact each other are automatically recorded as teaching points. In other words, a plurality of teaching points can be set in positions along the edge line L. Since the positions of the robot when the deburring tool 60 contacts the workpiece W are automatically recorded, the operator OP can easily create a trajectory tracing the edge line L of the workpiece W.

It should be noted that, in performing the direct teaching described above, the operator OP desirably gives consideration to bring the robot into contact with a workpiece at a point (for example, a corner portion) at which a direction of a trajectory greatly changes and a point at which a robot posture (tool posture) greatly changes, and record these points as teaching points.

The force control unit 151 performs control in such a way that the robot 10 (control portion) moves in a direction of an external force detected by the external force detector 71, i.e., a force applied to the robot 10 by the operator OP in the direct teaching. As such force control, control for operating the robot in a direction of an applied force at a speed proportional to magnitude of the force, impedance control, or damping control may be adopted. It should be noted that the impedance control is a technique for controlling a motion of the robot (control portion) according to an equation of motion representing a mechanical impedance characteristic defined by virtual inertial coefficient, viscous coefficient, and elastic coefficient. The damping control is a technique for determining a mechanical impedance characteristic, particularly based on a viscous coefficient.

In performing the direct teaching according to the present embodiment, the force control unit 151 desirably performs force control in such a way as to reduce a motion of moving away or jumping up from an object when the robot 10 contacts the object. The damping control is one technique capable of suppressing or reducing such behavior that the robot (control portion) moves away or jumps up from the object when the robot 10 contacts the object.

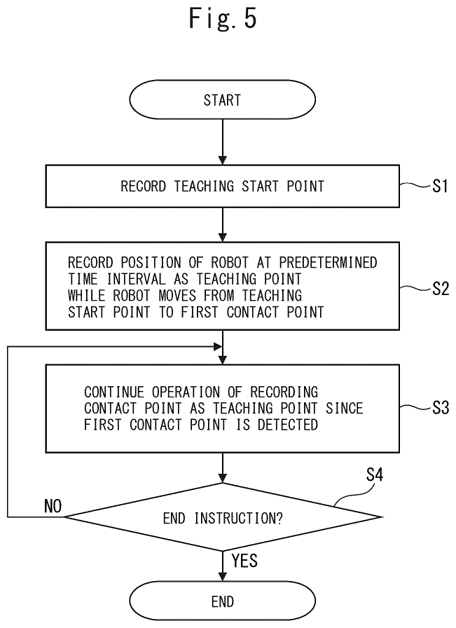

FIG. 5 illustrates, as a flowchart, a procedure of the direct teaching described above with reference to FIGS. 4A and 4B. The present direct teaching processing is activated in response to a predetermined operation of providing an instruction for starting the direct teaching. First, in response to an operation on the operation handle 82 by the operator OP, the program creation unit 156 (teaching point setting unit 161) records, as the teaching start point P1, a position of the robot when the direct teaching starts (step S1). Next, the teaching point setting unit 161 records positions of the robot 10 at predetermined time intervals as teaching points while the robot 10 is operated by the operator OP to move from the teaching start point P1 to a first contact point (step S2).

Next, the teaching point setting unit 161 records, as a teaching point, a position (contact point) of the robot 10 when the robot 10 first contacts the workpiece W (when first contact is detected by the contact detection unit 155), and also continues the operation of recording, as teaching points, positions (contact points) of the robot 10 when contact between the robot 10 and the workpiece W is detected (step S3). In this case, the teaching point setting unit 161 records only the contact point, and does not record a position when the robot 10 moves away from the workpiece W.

The teaching point setting unit 161 continues the operation of recording the contact point (step S3) until an instruction for ending the direct teaching is provided (step S4: NO). The instruction for ending the direct teaching may be provided by, for example, an operation on the operation switch 81 of the direct teaching device 80. When the end instruction is provided (step S4: YES), the present processing ends.

When the operation of obtaining the contact points as the teaching points is performed in step S3 described above, the teaching point setting unit 161 may apply one of the following rules (r1) and (r2).
(r1) After one teaching point (contact point) is recorded, a next teaching point (contact point) is not recorded until a predetermined time elapses.
(r2) After one teaching point (contact point) is recorded, a next teaching point (contact point) is not recorded until the robot (control portion) moves away from the one teaching point by a predetermined distance or more.

The number of teaching points can be prevented from being excessive by adopting one of the rules (r1) and (r2) described above.

The program creation unit 156 can provide a function for performing programming via a UI screen. Hereinafter, operations for performing the programming via the UI screen and the direct teaching will be described in relation to a case where the program creation unit 156 has a function of performing the programming on an icon basis. The UI screen is displayed on a display screen of the display unit 33 of the teach pendant 30, and can be operated via the operation unit 34 (such as a software key disposed on the display screen).

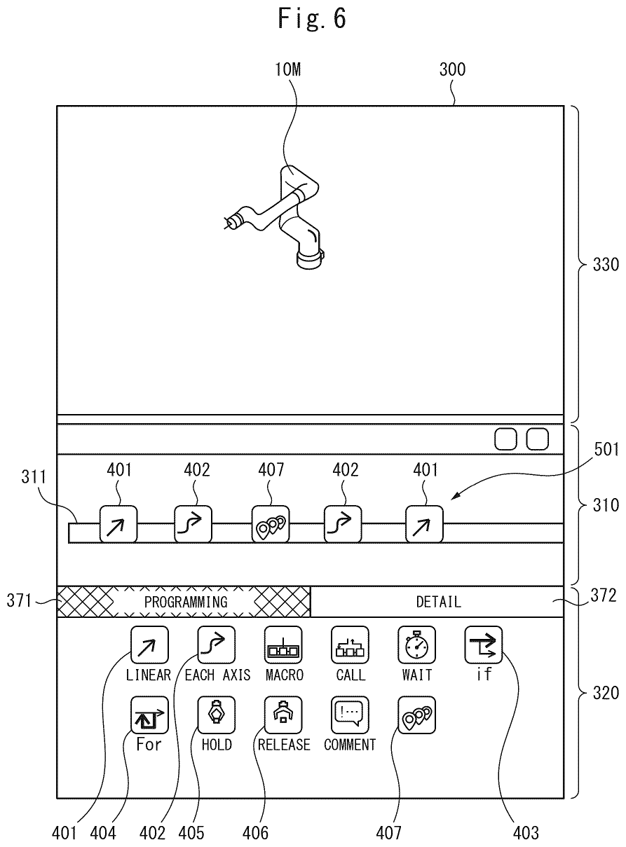

FIG. 6 is a diagram illustrating a program creation screen 300 generated by the display control unit 163 of the program creation unit 156. The program creation screen 300 includes a program display region 310, an icon display region 320, and a motion state display region 330 where a trajectory and the like of the robot are displayed.

The icon display region 320 is a region for displaying a list of icons that can be used for the programming. In the example illustrated in FIG. 6, a linear movement icon 401, an each axis movement icon 402, an if statement icon 403, a For loop icon 404, a hold icon 405, a release icon 406, and a direct teaching icon 407 are included in the icon display region 320.

The linear movement icon 401 is an icon corresponding to a command for linearly moving the robot (predetermined control portion). The each axis movement icon 402 is an icon corresponding to a command for causing the robot (predetermined control portion) to perform an each axis motion. The if statement icon 403 is an icon corresponding to a conditional branch command of a program. The For loop icon 404 is an icon corresponding to a loop condition command of a program. The hold icon 405 is an icon corresponding to a command for closing a hand and holding a workpiece. The release icon 406 is an icon corresponding to a command for opening the hand and releasing the workpiece. The direct teaching icon 407 is an icon corresponding to a command for performing the direct teaching.

The program display region 310 is a region for creating a program by arranging therein icons selected from the icon display region 320, and displaying a program. In the motion state display region 330, a robot model 10M can be moved in a simulated manner according to the taught contents.

An operator can perform the programming by selecting a desired icon from the icon display region 320 and arranging the icon in order along a timeline 311 in the program display region 310. In the example illustrated in FIG. 6, a robot program 501 including the linear movement icon 401, the each axis movement icon 402, the direct teaching icon 407, the each axis movement icon 402, and the linear movement icon 401 is created. It should be noted that, when the programming is performed by displaying the icon display region 320 on the program creation screen 300, an operator selects a programming tab 371. By selecting an icon in the program display region 310 and pressing a detail tab 372, a setting screen of the selected icon can be opened and detailed setting can be performed.

Next, an operation of generating a motion command of the direct teaching icon 407 will be described. The operator OP can open a setting screen of the direct teaching icon 407 by performing a predetermined operation on the program creation screen 300 in FIG. 6. An operation of selecting the direct teaching icon 407 in the program display region 310 and selecting the detail tab 372 may be used as the predetermined operation.

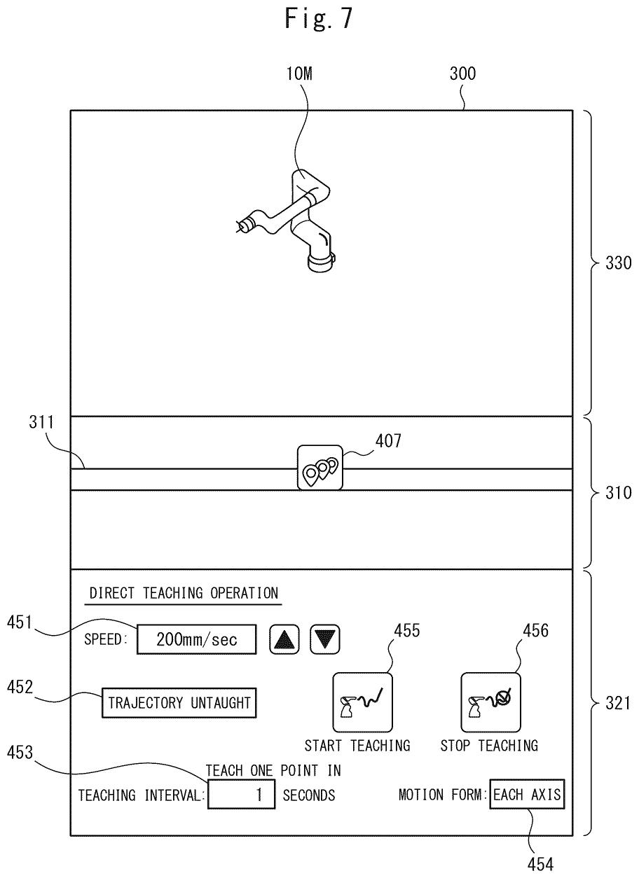

FIG. 7 illustrates a state where a setting screen 321 of the direct teaching icon 407 is displayed by selecting the direct teaching icon 407 in the program display region 310 in FIG. 6 and selecting the detail tab 372. As illustrated in FIG. 7, the setting screen 321 includes a speed setting field 451 for teaching, to the robot, a movement speed of the robot (predetermined control portion). An operator can teach, to the robot, the movement speed of the robot 10 by performing a numerical input in the speed setting field 451 or operating a button arranged next to the speed setting field 451.

The setting screen 321 includes a state display field 452 for displaying a state of the direct teaching. The state of the direct teaching is displayed in the state display field 452. In the example in FIG. 7, the direct teaching has not yet performed, and thus “TRAJECTORY UNTAUGHT” is displayed in the state display field 452.

The setting screen 321 includes a teaching start button 455 and a teaching stop button 456 for specifying a start and a stop of the direct teaching, respectively. An operator can start the direct teaching according to the present embodiment by pressing the teaching start button 455. Further, the operator can stop the direct teaching by pressing the teaching stop button 456.

A teaching interval specification field 453 for specifying a teaching interval is provided in the setting screen 321. The time interval used when positions on a trajectory are automatically recorded while the robot moves from the teaching start point to the first contact point as described in step S2 in FIG. 4 is specified in the teaching interval specification field 453. A motion form specification field 454 for specifying a motion form of the robot is included in the setting screen 321. A linear motion, an each axis motion, and the like can be specified in the motion form specification field 454. FIG. 7 illustrates an example in which the each axis motion (“each axis”) is specified as a motion form of the robot. In this case, the command generation unit 162 generates an each axis movement command as a motion command.

An operator can perform the direct teaching via such a UI screen by the method as described above with reference to FIGS. 4A to 4B. It is assumed that input of parameters has been performed via the setting screen 321, and the direct teaching has also been performed. The command generation unit 162 generates a program according to the acquired teaching points and the taught parameters. The operator is allowed to develop the direct teaching icon 407 so as to display contents of the direct teaching icon 407 by performing a predetermined operation on the direct teaching icon 407 (for example, an operation of double-clicking the direct teaching icon 407) on the program display region 310 of the program creation screen 300 in FIG. 6 or on a screen on which the setting screen 321 in FIG. 7 is displayed.

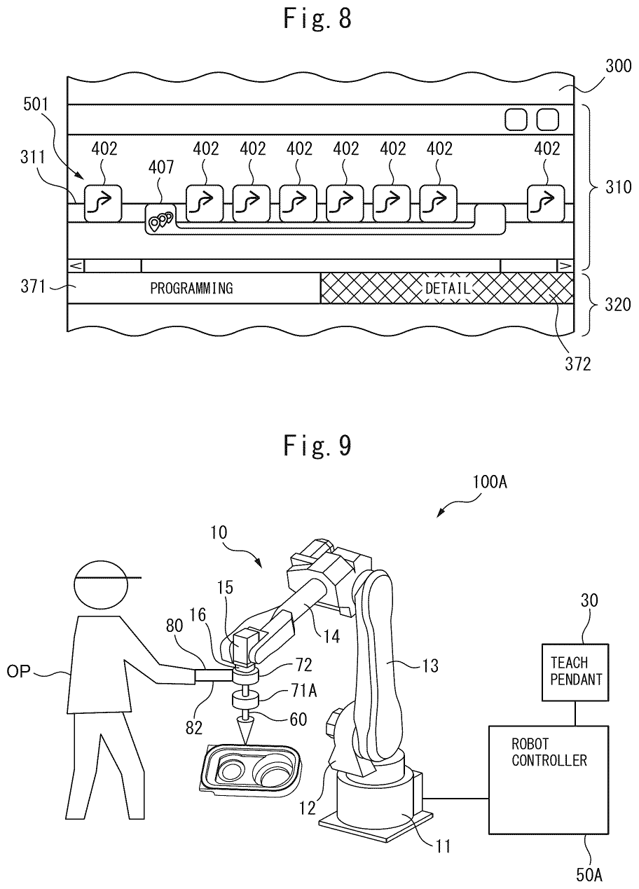

FIG. 8 illustrates an example where the direct teaching icon 407 is displayed in a developed state. As illustrated in FIG. 8, the direct teaching icon 407 is displayed in a widely extended state, and movement commands (herein, the each axis motion icon 402) for the respective teaching points obtained by the direct teaching are developed and displayed. In this way, by developing and displaying the direct teaching icon 407, the operator OP can confirm contents of the program created by the direct teaching. Further, teaching contents can be confirmed and adjusted by selecting the each axis movement icon 402 and opening a setting screen of the each axis movement icon 402 in the developed and displayed state illustrated in FIG. 8.

As described above, according to the first embodiment, an operator can easily perform teaching operation when a trajectory including contact points with a workpiece, such as a trajectory tracing an edge line or a surface of a workpiece, is taught by the direct teaching.

It should be noted that the functions provided by the robot controller 50 and the teach pendant 30 according to the first embodiment may collectively be called a teaching device.

### Second Embodiment

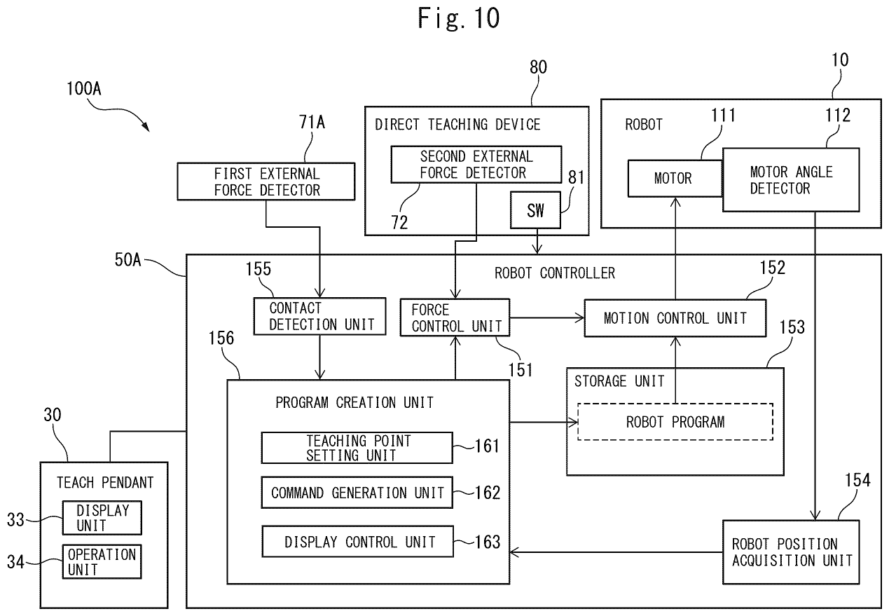

Hereinafter, a robot system 100A according to a second embodiment will be described. FIG. 9 is an apparatus configuration diagram of the robot system 100A according to the second embodiment. FIG. 10 is a functional block diagram of the robot system 100A. It should be noted that, in FIGS. 9 and 10, the same component as that of the robot system 100 according to the first embodiment is provided with the same reference sign.

The first embodiment is the configuration example in which the force control and the contact detection are performed based on an output of the external force detector 71. In the second embodiment, an external force detector for detecting contact with an object is used in addition to an external force detector used for the force control. In the present embodiment, it is assumed that a detector used for detecting contact with an object is referred to as a first external force detector (provided with a reference sign 71A in FIGS. 9 and 10), and a detector used for the force control is referred to as a second external force detector (provided with a reference sign 72 in FIGS. 9 and 10). As illustrated in FIGS. 9 and 10, the robot system 100A includes the second external force detector 72 arranged at a position corresponding to the external force detector 71 in the first embodiment, and the first external force detector 71A arranged at a position closer to a tip side of a robot 10 than a direct teaching device 80. Herein, the tip side of the robot refers to a side closer to a tool tip (i.e., a side closer to a workpiece). The second external force detector 72 can be formed of the same detector as the external force detector 71 in the first embodiment.

As illustrated in FIG. 9, in the robot system 100A, an output from the first external force detector 71A is input to a contact detection unit 155 of a robot controller 50A. As described in the first embodiment, the contact detection unit 155 detects contact between the robot and an object when a detected external force exceeds a predetermined threshold value, and the like. The first external force detector 71A is arranged on the robot 10 at a position closer to the tip side than a portion touched by an operator for the direct teaching. With this configuration, a contact force applied to the robot 10 by a deburring tool 60 of the robot 10 contacting the object can be more accurately detected.

More specifically, in a case where both of the detection of a force applied to the robot by an operator in the direct teaching and the detection of contact between the robot and a workpiece are performed by one external force detector, when the operator applies an operation force such that the robot moves with steep acceleration/deceleration in the air, there is a possibility that the robot controller erroneously detects that the contact with a workpiece has occurred. In this point, the possibility of occurrence of such a problem can be eliminated or reduced by separately providing a detector (first external force detector 71A) that detects contact with an object as in the present embodiment.

With the configuration above, a program creation unit 156 in the second embodiment can also provide the same function as that in a case of the first embodiment. In other words, in the second embodiment, the program creation unit 156 also allows an operator to easily perform the direct teaching of a trajectory including contact points with a workpiece W as described with reference to FIGS. 4A and 4B.

It should be noted that the first external force detector 71A can be formed of a force sensor or a load cell in the second embodiment, but a mechanical switch that detects contact with an external environment may be used as the first external force detector 71A. In this case, an arrangement position of the mechanical switch is set in such a way that the mechanical switch contacts a workpiece when an operator brings a tool into contact with the workpiece in the direct teaching.

Further, in the second embodiment, the program creation unit 156 can also provide a function of performing the direct teaching via a UI screen as illustrated in FIGS. 6 to 8.

In this way, in the second embodiment, an operator can also easily perform teaching operation when a trajectory including contact points with a workpiece, such as a trajectory tracing an edge line, a surface, and the like of a workpiece, is taught by the direct teaching.

It should be noted that the functions provided by the robot controller 50A and a teach pendant 30 according to the second embodiment may collectively be called a teaching device.

### Third Embodiment

Hereinafter, a robot system 100B according to a third embodiment will be described. The robot system according to the first embodiment and the second embodiment is the configuration example in which the function as the program creation unit 156 is included in the robot controllers 50 and 50A, but a configuration in which the function as the program creation unit 156 is included in a teach pendant (teaching device) is also possible. The robot system 100B according to the third embodiment is a configuration example in which the function as the program creation unit 156 is implemented on the teach pendant (teaching device).

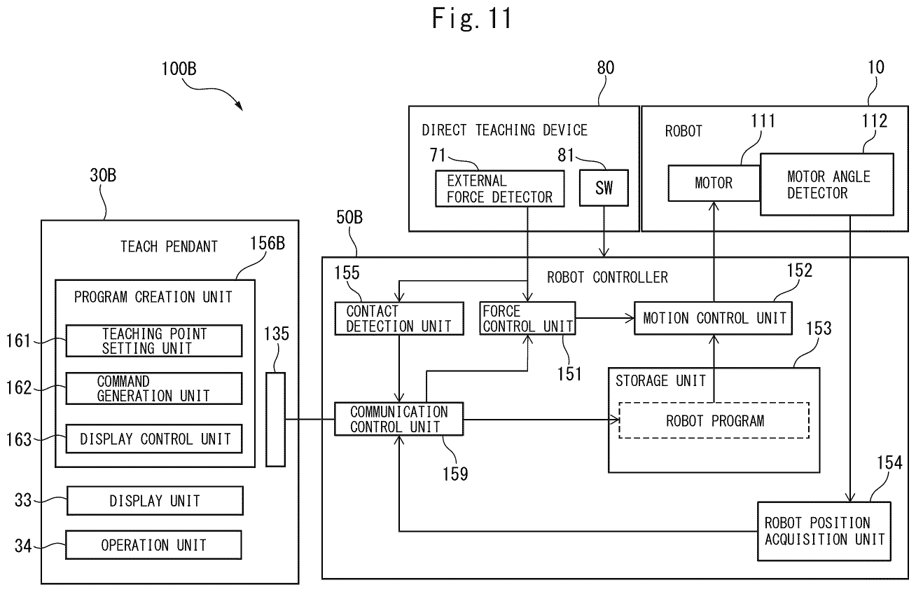

FIG. 11 illustrates a functional block diagram of the robot system 100B according to the third embodiment. In the robot system 100B according to the third embodiment illustrated in FIG. 11, a functional element equivalent to the functional element in the first embodiment is provided with the same reference sign. As illustrated in FIG. 11, in the present embodiment, the function as the program creation unit 156 arranged in the robot controller 50 in the first embodiment is arranged in a teach pendant (teaching device) 30B.

As illustrated in FIG. 11, a signal indicating contact with an object from a contact detection unit 155, information about a position and a posture of a robot from a robot position acquisition unit 154, and information about other various types of robot control are provided to a program creation unit 156B in the teach pendant 30B via a communication control unit 159 in a robot controller 50B and a communication control unit 135 in the teach pendant 30B. A notification signal to a force control unit 151 and a robot program that are generated by the program creation unit 156B are provided to a robot controller 50B via the communication control unit 135 and the communication control unit 159.

With the configuration above, the program creation unit 156B in the third embodiment can also provide the same function as that of the program creation unit 156 in the first embodiment. In other words, in the third embodiment, the program creation unit 156B also allows an operator to easily perform the direct teaching of a trajectory including contact points with a workpiece W as described with reference to FIGS. 4A and 4B.

Further, in the third embodiment, the program creation unit 156B can also provide a function of performing the direct teaching via a UI screen as illustrated in FIGS. 6 to 8.

In this way, in the third embodiment, an operator can also easily perform teaching operation when a trajectory including contact points with a workpiece, such as a trajectory tracing an edge line, a surface, and the like of a workpiece, is taught by the direct teaching.

It should be noted that, as a modification example of the configuration in the third embodiment illustrated in FIG. 11, as described in the second embodiment, a second external force detector 72 may be mounted on a robot 10, and contact between the robot 10 and an object may be detected based on an output of the second external force detector 72.

As described above, according to each of the embodiments, an operator can easily perform teaching operation when a trajectory including contact points with a workpiece, such as a trajectory tracing an edge line or a surface of a workpiece, is taught by the direct teaching.

The present invention has been described above by using the typical embodiments, but it will be understood by those of ordinary skill in the art that changes, other various changes, omission, and addition may be made in each of the embodiments described above without departing from the scope of the present invention.

Distribution of the functional blocks in the functional block diagrams illustrated in FIGS. 3, 10, and 11 is an example, and various modification examples of an arrangement of the functions in the robot system can be configured. For example, in the functional block diagram illustrated in FIG. 11, a configuration in which a function as a command generation unit 162 arranged in the program creation unit 156B of the teach pendant 30B is arranged on the robot controller 50B side is also possible. In this case, a teaching point recorded on the teach pendant 30B side is provided to the robot controller 50B side, and a robot program is generated on the robot controller 50B side.

The functional block illustrated in FIGS. 3, 10, and 11 may be achieved by executing various types of software stored in a storage device by a processor of the robot controller or the teaching device, or may be achieved by a configuration in which hardware such as an application specific integrated circuit (ASIC) is a main body.

The program for executing various types of processing such as the direct teaching processing in the embodiments described above can be recorded in various computer-readable recording media (for example, a ROM, an EEPROM, a semiconductor memory such as a flash memory, a magnetic recording medium, and an optical disk such as a CD-ROM and a DVD-ROM).

### REFERENCE SIGNS LIST

10 Robot
30, 30B Teach pendant
31 Processor
32 Memory
33 Display unit
34 Operation unit
35 Input/output interface
50, 50A Robot controller
51 Processor
52 Memory
53 Input/output interface
54 Operation unit
60 Deburring tool
71 External force detector
71A First external force detector
72 Second external force detector
80 Direct teaching device
81 Operation switch
100, 100A, 100B Robot system
111 Motor
112 Motor angle detector
135 Communication control unit
151 Force control unit
152 Motion control unit
153 Storage unit
154 Robot position acquisition unit
155 Contact detection unit
156 Program creation unit
159 Communication control unit
161 Teaching point setting unit
162 Command generation unit
163 Display control unit
300 Program creation screen
310 Program display region
320 Icon display region
321 Setting screen
330 Motion state display region

1. A robot controller for controlling a robot, the robot controller comprising
a teaching point setting unit configured to set, as a teaching point of a robot program, a position of the robot when contact between the robot and an object is detected, based on an output of a first detector capable of detecting contact with the object, the first detector being mounted on the robot.

2. The robot controller according to claim 1, wherein
the first detector is an external force detector that detects an external force,
the robot controller further comprises a force control unit configured to perform control in such a way that the robot moves according to the external force detected by the first detector, and
the teaching point setting unit sets, as the teaching point of the robot program, a position of the robot when contact between the robot and the object is detected while the robot is moving under control of the force control unit.

3. The robot controller according to claim 1, further comprising
a force control unit configured to perform control in such a way that the robot moves according to an external force detected by a second detector being mounted on the robot and used for detecting an external force, wherein
the teaching point setting unit sets, as the teaching point of the robot program, a position of the robot when contact between the robot and the object is detected while the robot is moving under control of the force control unit.

4. The robot controller according to claim 2, wherein
the force control unit performs force control by damping control.

5. The robot controller according to claim 1, wherein,
after the teaching point setting unit sets one teaching point, the teaching point setting unit operates in such a way as not to set a next teaching point until a predetermined time elapses.

6. The robot controller according to claim 1, wherein
the teaching point setting unit operates in such a way that an interval between one teaching point and a next teaching point is equal to or more than a predetermined distance.

7. A robot system comprising:
a robot on which a first detector capable of detecting contact with an object is mounted; and
a teaching point setting unit configured to set, as a teaching point of a robot program, a position of the robot when contact between the robot and the object is detected, based on an output of the first detector.

8. The robot system according to claim 7, wherein
the first detector is an external force detector that detects an external force,
the robot system further comprises a force control unit configured to perform control in such a way that the robot moves according to an external force detected by the first detector, and
the teaching point setting unit sets, as the teaching point of the robot program, a position of the robot when contact between the robot and the object is detected while the robot is moving under control of the force control unit.

9. The robot system according to claim 7, wherein
a second detector for detecting an external force is further mounted on the robot,
the robot system further comprises a force control unit configured to perform control in such a way that the robot moves according to an external force detected by the second detector, and
the teaching point setting unit sets, as the teaching point of the robot program, a position of the robot when contact between the robot and the object is detected while the robot is moving under control of the force control unit.

10. The robot system according to claim 9, wherein
the first detector is arranged at a position closer to a tip side of the robot than the second detector.

11. The robot system according to claim 8, wherein
the force control unit performs force control by damping control.

12. The robot system according to claim 7, wherein,
after the teaching point setting unit sets one teaching point, the teaching point setting unit operates in such a way as not to set a next teaching point until a predetermined time elapses.

13. The robot system according to claim 7, wherein
the teaching point setting unit operates in such a way that an interval between one teaching point and a next teaching point is equal to or more than a predetermined distance.

14. A teaching device for teaching a robot, the teaching device comprising
a teaching point setting unit configured to set, as a teaching point of a robot program, a position of the robot when contact between the robot and an object is detected, based on an output of a first detector capable of detecting contact with the object, the first detector being mounted on the robot.
